(19) United States
(12) Patent Application Publication
(10) Pub. No.: US 2007/0209994 A1
(43) Pub. Date: Sep. 13, 2007

(54) SUPPORTED CURVED HOLLOW FIBRE MEMBRANE

(76) Inventors: Pierre Lucien COTE, Dundas (CA); Steven Kristian PEDERSEN, Burlington (CA); Marcell MARSCHALL, Agostyan (HU)

Correspondence Address: BERESKIN & PARR (MISSISSAUGA) / GE, SCOTIA PLAZA, 40 KING STREET WEST, 40TH FLOOR, TORONTO, ON, M6H-3V2, US

(21) Appl. No.: 11/683,684

(22) Filed: Mar. 8, 2007

Related U.S. Application Data
(60) Provisional application No. 60/780,804, filed on Mar. 9, 2006.

(51) Int. Cl. B01D 63/00; B01D 69/00

(52) U.S. Cl. 210/321.89; 210/500.23

(57) ABSTRACT

A curved hollow fiber membrane comprises a support and a film. The support is curved before being coated with the film. The membrane may be used, for example, in a filtration module.

This is an application claiming the benefit under 35 USC 119(e) of U.S. Application Ser. No. 60/780,804 filed Mar. 9, 2006. U.S. Application Ser. No. 60/780,804 is incorporated herein, in its entirety, by this reference to it.

### FIELD

This invention relates to hollow fibre membranes, methods of making hollow fibre membranes and filtration devices having hollow fibre membranes.

### BACKGROUND

In U.S. Pat. No. 5,472,607 a hollow fibre membrane (“fibre”) comprises a tubular macroporous support coated on its outer surface with a thin tubular asymmetric semipermeable film of polymer. The film, by itself, is non-self-supporting. The support itself is so flexible (flaccid) that it does not have a circular cross-section and collapses with finger pressure. Such a tube of knitted or woven braid no greater than 2.5 mm o.d., having interstitial voids which are non-uniformly shaped by the “ends” which are braided, is coated with a “dope” of polymer, then coagulated in a bath to form the film. Yet, after coating, the braided membrane can withstand up to 1500 psig in hydraulic compression forces before a straight-line relationship between flux and pressure begins to flatten out. The voids are relatively much larger than pores in the film. These voids are small enough to inhibit substantial penetration of the dope which lies superficially supported on the upper portion of the braid. Viewed in an elevational cross-sectional view looking down the longitudinal axis of the dope-coated braid, the dope extends over less than 33% of the outer portion of the braid's cross-sectional area. This thin coating of dope is made possible by a unique coating nozzle having sequential rounding and sizing orifices through which the braid is advanced by pulling it without unduly distorting the shapes of the voids in the braid. The shapes and sizes of the braid are thus retained except that the braid is distended into an essentially circular shape because of the tensile forces exerted by the coagulating dope. Hollow fiber membranes made as disclosed herein are used to make fluid-fluid separations, the braid and film being tailored to the purpose at hand.

In U.S. Pat. No. 6,354,444 an asymmetric membrane comprising a tubular polymer film in combination with a tubular braid on which the film is supported, requires the braid be macroporous and flexible, yet sufficiently strong to withstand continuous flexing, stretching and abrasion during use for microfiltration (MF) or ultrafiltration (UF). The specifications for a braid of a long-lived membrane are provided. A membrane is formed by supporting a polymer film in which particles of calcined α-alumina are dispersed, on the defined tubular braid.

In International Publication No. WO 2005/037917 a method of synthesizing a polymeric membrane is described in which a polymer, for example a polyvinylidene polymer or a terpolymer of ethylene, chlortrifluoroethylene and an acrylic monomer is heated and blended with a solvent. The solvent may be a high boiling latent solvent, for example butyl benzyl phthalate or tri iso nonyl trimellitate. The heated blend is shaped, which may involve casting on a supporting material such as a braided tube. Subsequently, the blend is cooled to thereby induce polymeric membrane formation on the supporting material.

All of the patents and publications listed above are incorporated herein in their entirety.

### SUMMARY

The following summary is intended to introduce the reader to various aspects of the invention but is not intended to define the invention which may reside in a combination or sub-combination of various elements or steps found in the following summary or other parts of this document, such as the detailed description or claims.

This specification describes a hollow fibre membrane comprising a substrate and a porous film. The substrate may be a tube formed of a plurality of filaments, for example a woven or braided tube. The film may be polymeric and may cover the outside of the support. The hollow fiber membrane may be curved along its length.

This specification also describes a method of making a hollow fibre membrane. A substrate is formed by arranging filaments into a tube. Before, during or after forming the filaments into a tube, some or all of the length of some or all of the filaments is presently or latently modified. As or after the support is formed, a length modification is made or a latent length modification is completed to some of the filaments such that the support is made to curve along its length. The support is coated with a porous film to produce a curved hollow fiber membrane.

This specification also describes a filtration device having curved, supported, hollow fiber membranes. The device comprises one or two potting heads. A plurality of the curved supported hollow fiber membranes are potted into the one or two potting heads. Where there are two headers, the membranes may be slack or tensioned between the potting heads but to a degree that does not fully straighten the curves in the membranes

This specification also describes various further combinations of two or more of the aspects or sets of features discussed above and various additional features. An embodiment will be described below having the aspects discussed above as well as various additional features.

### BRIEF DESCRIPTION OF THE DRAWINGS

FIG. 1 shows side views of various curved membranes.

FIG. 2 shows a cross-section of a curved membrane.

FIG. 3 shows an elevation view of a filtration module having curved membranes.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document, for example the right to claim such an invention in a continuing application, and do not abandon, disclaim or dedicate to the public any such invention by its disclosure in this document.

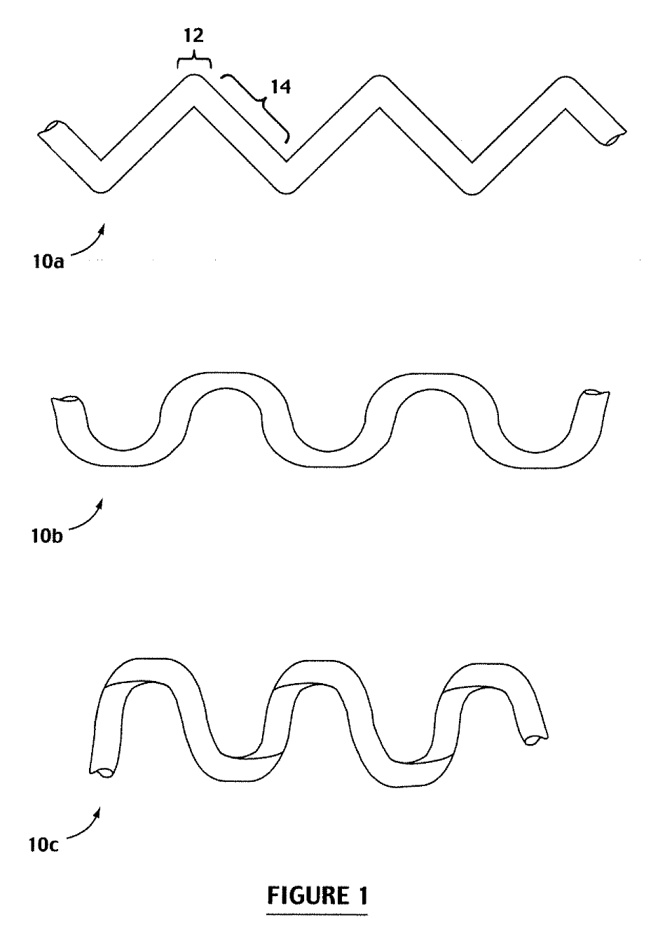

FIG. 1 shows three curved hollow fiber membranes 10. The curvature is inherent to the shape of the membrane 10 rather than a result of positioning of the membranes 10. Although the membrane 10 could be made straight by applying sufficient tension, when a length of membrane 10 of roughly 10 cm in length is hung by one of its ends or placed on a table, the membrane 10 assumes a curved shape along its length. Membrane 10a is crimped, or has discrete generally curved sections 12 separated by discrete generally straight sections 14. Membrane 10b has a continuous two dimensional curve, that is a continuous curve generally within a plane. Membrane 10c has a continuous three-dimensional curve, more specifically a spiral. The membrane 10 might also have other continuous or discontinuous two or three-dimensional curvatures.

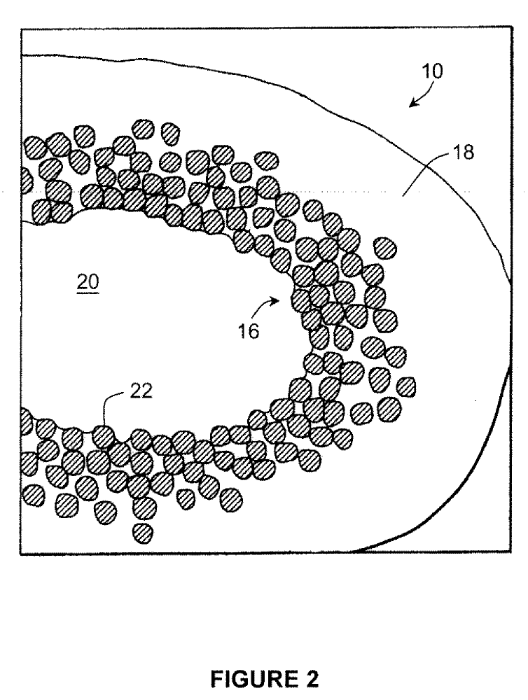

FIG. 2 shows a cross-section of a membrane 10. The membrane 10 has a support 16, a film 18 and open lumen 20. The film 18 covers the outside of the support 16. The film 18 may generally lie on the outer surface of the support 16, may penetrate partially, for example between 10% and 90% into the thickness of the support 16, may extend to the interior of the support 16 (as shown) or may enter into the lumen 20. The fibre 18 may be between 0.01 and 0.3 mm thick between the outer surface of the support 16 and the outer surface of the film 18. The film 18 may be polymeric and have pore sizes in the microfiltration range or smaller. The support 16 may comprise multi-filaments 22 formed into the shape of a tube, each multi-filament 22 may comprise many, for example between 25 and 750 filaments. A number of multi-filaments 22, for example 1 to 3, may be plied together or arranged to form a yarn or thread.

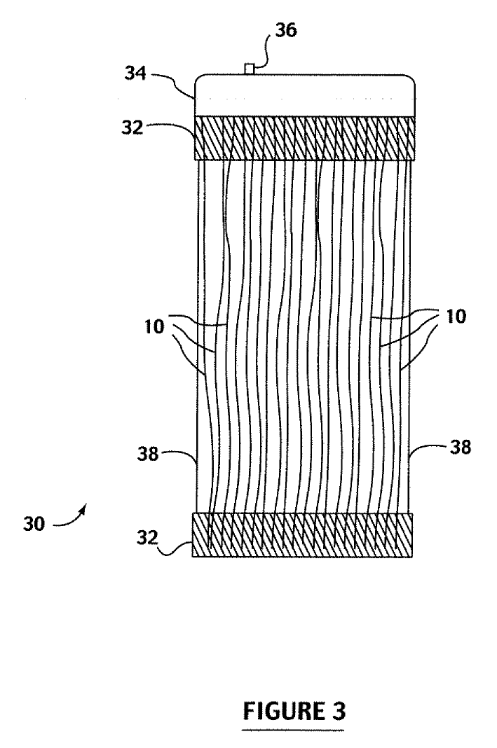

FIG. 3 shows a filtration module 30 having a number of membranes 10 potted in a potting head 32. The ends of the fibres are open to a face of at least one potting head 32. The face of a potting head with open fibre ends is covered by a permeate pan 34 with a port 36 for removing permeate. Two potting heads 32 may be spaced by spacers 38. The length of the membranes 10 relative to a pair of potting heads 32 may be such that the membranes 10 are slightly slackened or are under tension, but not so much tension as to completely remove the curvature of the membranes 10. In this way, when the membranes 10 are scoured with bubbles, the membranes 10 may sway and move against each other.

To make the membrane 10, a curved support 16 is made. The curved support 16 may be temporarily wound on a spool. The curved support 16 may then be pulled through a coating nozzle and coated with a liquid dope, or a mixture of a polymer and a solvent or diluent. The tensile force pulling on the support 16, countered by the drag of the support 16 against the coating nozzle, may cause the support 16 to temporarily partially straighten. After the support 16 exits the coating nozzle coated with the dope, it is further processed, for example according to a TIPS or NIPS process, to convert the liquid dope into the porous film 18. When tension is released, the resulting membrane 10 returns at least partially to the curved shape of the support 16. The amplitude of the curvature may be less than for the uncoated support 16, particularly if support 16 was kept under sufficient tension to make it generally straight while the dope solidified, but the resulting membrane 10 is still curved.

Various methods may be used to produce the curved support 16. In some methods, a support is knitted or braided in a machine having many, for example between 16 and 60, carriers. One or more carriers, for example between 1 and 10, which place filaments 22 along parallel paths may have a different tension, for example an increased tension, while forming the support 16. The resulting support 16 will have a spiral curvature after the support 16 leaves the machine where it was made.

In another method, filaments 22 placed by one or more, for example between 1 and 10, of the carriers along parallel paths are given a different current or latent length related quality or modification. For example, the filaments 22 on some of the carriers may be made of a different material that has different elastic properties or heat or chemical shrinkage related properties relative to other filaments 22, or be un-shrunken whereas the other carriers carry pre-shrunken filaments 22. After forming the support 16, the support 16 may be treated to activate the latent length related property, if necessary. For example, if some of the filaments 22 have a different elastic modulus, releasing tension on the support 16 allows the support 16 to take a curved shape. If some of the filaments have a different maximum resilient elongation, the support 16 may be stretched beyond the maximum resilient elongation of some but not all of the filaments 22. If some of the filaments 22 were pre-shrunk before forming the support 16, the support 16 may be post shrunk, for example by applying heat or chemicals, to shrink the non-pre-shrunk filaments 22 to an extent greater than for the pre-shrunk filaments 22. If some of the filaments 22 have different shrinking properties, the support is post shrunk such that some of the filaments 22 shrink to a different degree than the others.

In other methods, the support 16 is formed, optionally generally without curvature and without latent length related properties of the filaments, and treated after being formed to produce curvature. For example, the support 16 may be passed over a heated roller or around a heated tube to cause non-symmetrical shrinking. Alternately, the support 16 may be crimped, for example by passing it through a crimping press or iron.

The invention or inventions which are currently claimed in this document are described in the following claims.

We claim:

1. A curved supported hollow fibre membrane.

2. The membrane of claim 1 comprising a curved support coated with a porous film.

3. The membrane of claim 2 wherein the curved support comprises a set of filaments formed into a tube.

4. A filtration module having a curved supported hollow fibre membrane.

5. The filtration module of claim 4 wherein the membrane is attached at an end to a potting head.

6. The filtration module of claim 5 wherein the membranes are attached at second ends to a second potting head.

7. The filtration module of claim 6 wherein the membranes are in a slackened state or under a tension not sufficient to straighten the curves of the membrane.

8. A method of making a curved supported hollow fibre membrane comprising the steps of forming a curved support and coating the curved support with a porous film.

9. The method of claim 8 wherein the step of forming a curved support further comprises forming a set of filaments into a tube while maintaining a different tension on a sub-set of the filaments which follow generally parallel paths.

10. The method of claim 8 wherein the step of forming a curved support further comprises the steps of forming a tubular support having a sub-set of filaments having generally parallel paths with a latent length related property and activating the latent length related property to cause the support to curve.

11. The method of claim 8 wherein the step of forming a curved support comprises the steps of forming a tubular support and then treating the tubular support to curve it.
